(19) United States
(12) Patent Application Publication
(10) Pub. No.: US 2026/0043361 A1
(43) Pub. Date: Feb. 12, 2026

(54) METHOD FOR MANAGING THE EXITING OF A SPECIFIC-CONSUMPTION MODE OF AN AIRCRAFT TURBINE ENGINE

(71) Applicant: SAFRAN HELICOPTER ENGINES, Bordes (FR)

(72) Inventors: Sophie Humbert, Moissy-Cramayel (FR); Olivier Bedrine, Moissy-Cramayel (FR); Sébastien Alexis Matthieu Carles, Moissy-Cramayel (FR)

(73) Assignee: SAFRAN HELICOPTER ENGINES, Bordes (FR)

(21) Appl. No.: 19/101,504

(22) PCT Filed: Aug. 8, 2023
(86) PCT No.: PCT/FR2023/051254

§ 371 Date: Feb. 5, 2025

(30) Foreign Application Priority Data
Aug. 12, 2022 (FR) FR2208296

(51) Int. Cl. F02C 9/42; F01D 19/00; F01D 21/00

(52) U.S. Cl. CPC F02C 9/42; F01D 19/00; F01D 21/003; F05D 2220/329; F05D 2260/85; F05D 2270/121; F05D 2270/13

(57) ABSTRACT

This method for managing the exiting of a specific-consumption mode of an aircraft comprises a step of identifying a need to reactivate a turbine engine in the nominal mode of said turbine engine, and a step of: —normal reactivation of the turbine engine in the nominal mode for the turbine engine for a first duration when a first condition is met; —accelerated reactivation of the turbine engine in the nominal mode for the turbine engine for a second duration when a second condition is met; —rapid reactivation of the turbine engine in the nominal mode of the turbine engine for a third duration when a third condition is met, the first duration being longer than the second duration, and the second duration being longer than the third duration.

### TECHNICAL FIELD

The present invention relates to the management of aircraft turbine engine activations.

In particular, the present invention relates to helicopters with a twin-engine architecture, one of the two engines of which can operate in a deactivated or energy-saving mode, also called standby mode.

In general, the invention applies to all aircraft comprising at least two engines.

### PRIOR ART

A turbine engine, and particularly an aircraft turbine engine, for example a helicopter turbine engine, must be started before it can provide thrust power or mechanical power to the rotor. In particular, starting comprises heating the components of the turbine engine as well as rotating the turbine.

During a flight phase of an aircraft comprising a twin-turbine engine architecture, one turbine engine may sometimes be switched off due to the implementation of a particular flight mode, for example an energy-saving mode, also called standby mode.

In this standby mode, moreover detailed in document FR2967132A1, the turbine engine remains in rotation at a low speed by being driven by combustion gases or by an assistance device such as an electric machine. In this standby mode, the combustion chamber can be switched off. Alternatively, the combustion chamber is switched on while the turbine engine is or is not assisted in the rotation thereof.

To exit this standby mode, it is possible to restart the engine using either a conventional restart or with a rapid restart. Document FR3027058A1 particularly mentions that a normal restart takes place over a duration of 30 seconds to 1 minute, while a rapid restart takes place over a duration of around 10 seconds.

### DISCLOSURE OF THE INVENTION

The aim of the present invention is therefore to overcome the aforementioned drawbacks and to provide management of the exit of a standby mode adapted to each situation in which the aircraft is found.

The object of the present invention is a method for managing the exiting of a specific-consumption mode of an aircraft equipped with a first turbine engine operating in a nominal mode and a second turbine engine operating in a standby mode or in a consumption mode intermediate to the standby mode and to the nominal mode of the second turbine engine. Nominal mode means the normal operating mode in which a turbine engine provides power. The method comprises a step of identifying a need to reactivate the second turbine engine in the nominal mode of said second turbine engine and a step of:
normal reactivation for a first duration of the second turbine engine in the nominal mode of said second turbine engine when the aircraft and/or the first turbine engine meets a first condition;
accelerated reactivation for a second duration of the second turbine engine in the nominal mode of said second turbine engine when the aircraft and/or the first turbine engine meets a second condition;
rapid reactivation for a third duration of the second turbine engine in the nominal mode of said second turbine engine when the aircraft and/or the first turbine engine meets a third condition,
the normal reactivation being preferred over the accelerated reactivation, the accelerated reactivation also being preferred over the rapid reactivation, the first duration being longer than the second duration, and the second duration being longer than the third duration.

Thus, the second turbine engine can be reactivated at various durations according to various reactivation steps, which makes it possible to maximise the benefits, and particularly to limit the impacts of a reactivation to the precise need of safety. Indeed, the shorter the reactivation, the more damage it causes to the turbine engine, but also the safer it is.

Advantageously, the step of identifying a need to reactivate the second turbine engine in the nominal mode of said second turbine engine comprises a step of detecting an anomaly of at least one operating parameter of the first turbine engine or comprises a step of receiving by the second turbine engine a reactivation instruction issued by an on-board computer and/or an aircraft pilot.

In one implementation, the step of normal reactivation and/or the step of accelerated reactivation and/or the step of rapid reactivation comprises a step of assisting the second turbine engine by an electric machine of the aircraft.

Advantageously, the step of normal reactivation comprises a step of thermally stabilising at a predefined temperature the second turbine engine or a step of gradually increasing the power of the second turbine engine until the powers provided between the first and second turbine engines are balanced, the step of normal reactivation further comprising implementing a fuel flow rate law making a reactivation time of between 1 and 3 minutes possible.

Advantageously, the step of accelerated reactivation comprises implementing a fuel flow rate law making a reactivation time of between 25 seconds and 45 seconds possible.

In one implementation, the step of rapid reactivation comprises using a specific starting system configured to implement an assist torque and a fuel flow rate law making a reactivation time of between 5 seconds and 15 seconds possible.

Advantageously, the first condition comprises receiving by the second turbine engine a reactivation instruction issued by an on-board computer and/or an aircraft pilot.

Advantageously, the second condition comprises detecting a failure on the first turbine engine, for example among the loss of redundancy of a sensor, an excessive oil temperature, the loss of an energy source of the aircraft, or comprises detecting flight conditions requiring operation in nominal mode of the second turbine engine, or comprises receiving by the second turbine engine a reactivation instruction issued by an on-board computer and/or an aircraft pilot.

Advantageously, the third condition comprises detecting a fault on the first turbine engine, for example detecting an anomaly in the values for the fuel flow rate, and/or the temperature and/or the output rotational speed of a high-pressure turbine of the turbine engine, and/or the output pressure of a compressor of the turbine engine, and/or the torque, and/or detecting the switching off of a combustion chamber of the turbine engine, and/or a leak in an oil circuit, and/or a leak in a fuel circuit, and/or detecting a swarf, and/or an inability to regulate the performance of the turbine engine, and/or an inconsistency between the power demand and the power supplied, and/or comprises detecting flight conditions requiring operation in nominal mode of the second turbine engine, or comprises receiving by the second turbine engine a reactivation instruction issued by an on-board computer and/or an aircraft pilot.

In one implementation, the method is implemented continuously by a computer of the first and/or of the second turbine engines as long as the second turbine engine is not in the nominal operating mode thereof, the first, second and third conditions also comprising a condition for maintaining the flight altitude of the aircraft over the time necessary for reactivating the second turbine engine.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 is a schematic diagram of the various states of a second turbine engine during the implementation of the method according to the invention; and

FIG. 2 illustrates the steps of the method according to the invention.

### DETAILED DISCLOSURE OF AT LEAST ONE EMBODIMENT

In one implementation, the method according to the invention is implemented in an aircraft, for example a helicopter, comprising a first turbine engine and a second turbine engine providing power to a main transmission gearbox of the aircraft.

The first and second turbine engines each comprise a compressor that raises the pressure of a gas at the inlet of the turbine engines, a combustion chamber that raises the temperature of the compressed gas, and an expansion turbine that also makes it possible to drive the compressor.

In particular, the first and second turbine engines are for example free turbine engines, the expansion turbine being divided into a high-pressure turbine, also called a gas generator turbine, and a power turbine also called a free turbine.

The method according to the invention is in particular implemented when the aircraft operates with a specific-consumption mode such as the energy saving mode, particularly when one of the two turbine engines, for example the first turbine engine, operates in a nominal mode, in other words in an operating mode offering standard performances and making it possible for the aircraft to move in the atmosphere, and when the second turbine engine operates in a deactivated mode. In particular, deactivated mode means a standby mode of the second turbine engine, or a consumption mode intermediate to the standby mode and to the nominal mode of the second turbine engine.

The first and second turbine engines may be interchanged in the implementation of the method according to the invention.

The intermediate consumption mode is for example an operating mode of the second turbine engine when the latter switches from the nominal mode thereof to the standby mode thereof, or from the standby mode thereof to the nominal mode thereof.

The standby mode is a consumption mode making it possible for the second turbine engine of the aircraft to have low fuel consumption, while making rapid reactivation possible, for a situation where the aircraft would need both turbine engines or in the case where the first turbine engine would have a failure.

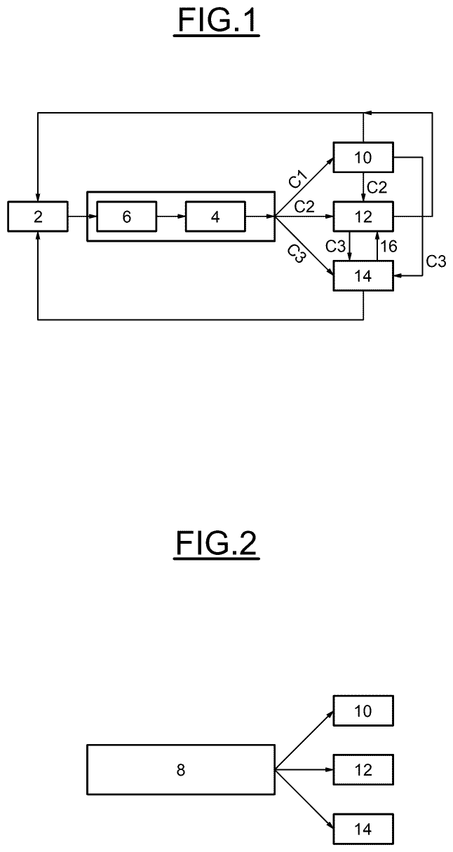

FIG. 1 schematically shows a schematic diagram of the various states of a second turbine engine during the implementation of the method according to the invention, in other words during reactivation steps of the second turbine engine.

FIG. 1 particularly shows a nominal consumption mode 2 of the second turbine engine, a standby mode 4, as well as a consumption mode 6 intermediate to the standby mode 4 and to the nominal mode 2. The method according to the invention applies to the second turbine engine in particular when the latter is in an operating mode such as the standby mode 4 or the intermediate consumption mode 6. In the latter modes, the combustion chamber can be switched off, while the turbine of the gas generator is rotated at low speed, for example by means of an electric machine. Alternatively, the combustion chamber is switched on and the turbine of the gas generator comprises or does not comprise rotational drive assistance.

FIG. 2 schematically shows the various steps of the method for managing the exiting of a specific-consumption mode of the aircraft.

The method comprises a step 8 of identifying a need to reactivate the second turbine engine in the nominal mode 2 of said second turbine engine.

The step 8 of identifying a need to reactivate the second turbine engine comprises in particular a step (not shown) of detecting an anomaly of at least one operating parameter of the first turbine engine and/or of the aircraft. In particular, if the anomaly detected, for example representative of a leak in a circuit or more broadly of a loss of performance, results in a failure that makes the use alone of the first turbine engine insufficient for the flight of the aircraft, a need to reactivate the second turbine engine is identified.

Alternatively, the step 8 of identifying a need to reactivate the second turbine engine comprises a step (not shown) of receiving a reactivation instruction issued by an on-board computer and/or by an aircraft pilot. Indeed, the on-board computer of the aircraft can at any time provide an instruction indicating that the second turbine engine must be required in nominal mode. Similarly, an aircraft pilot may wish to require the reactivation of the second turbine engine, for example by pressing a button, in order to perform a particular manoeuvre.

Once a need to reactivate the second turbine engine has been identified, the method comprises implementing a reactivation step that can take three different forms, the three types of reactivation being able to impact the ageing of the second turbine engine differently.

A step 10 of normal reactivation is performed for a first duration of the second turbine engine in the nominal mode of said second turbine engine when the aircraft and/or the first turbine engine and/or the pilot meets a first condition C1. This is the longest possible reactivation step, in particular it makes it possible to preserve the mechanical integrity of the second turbine engine.

In one implementation, the first condition C1 comprises receiving by the second turbine engine a reactivation instruction issued by an on-board computer and/or by an aircraft pilot.

This step 10 of normal reactivation comprises a step of thermally stabilising at a predefined temperature the second turbine engine. Alternatively, this step 10 comprises a step of gradually increasing the power of the second turbine engine until the powers supplied between the first and second turbine engines are balanced.

The step 10 of normal reactivation also comprises implementing a fuel flow law and optimising the torque making a reactivation time of between 1 and 3 minutes possible.

The step 10 thus makes it possible to gradually change the temperature of the components of the second turbine engine.

This step 10 of normal reactivation is the most commonly used reactivation step as it is often a non-urgent reactivation. This is the step that has the least impact on the ageing of the turbine engine and is therefore preferred.

The second type of reactivation is the implementation of a step 12 of accelerated reactivation during a second duration of the second turbine engine in the nominal mode of said second turbine engine, and this when the aircraft and/or the first turbine engine and/or the second turbine engine meets a second condition C2.

The second condition C2 comprises for example detecting a failure, and more broadly an anomaly resulting in a failure of the first turbine engine, for example the loss of redundancy of a sensor, an excessive oil temperature, or the loss of an energy source of the aircraft.

Alternatively, the second condition C2 comprises detecting flight conditions requiring operation in nominal mode of the second turbine engine. For example, the measured atmospheric pressure is not compatible with the use of a single turbine engine in nominal mode, and it is therefore necessary to reactivate the second turbine engine. Alternatively, the second condition C2 comprises receiving by the second turbine engine a reactivation instruction issued by an on-board computer and/or an aircraft pilot.

The step 12 of accelerated reactivation is substantially analogous to step 10 of normal reactivation, but comprises implementing a fuel flow rate law making a reactivation time of between 25 seconds and 45 seconds possible. This step 12 of accelerated reactivation is therefore shorter, particularly thanks to the absence of a step of thermal stabilisation and makes it possible to reactivate the second turbine engine more rapidly. This reactivation nevertheless implies an impact on the ageing of the second turbine engine.

The third type of reactivation is the implementation of a step 14 of rapid reactivation for a third duration of the second turbine engine in the nominal mode of said second turbine engine when the aircraft and/or the first turbine engine meets a third condition C3.

The third condition C3 also comprises detecting a fault on the first turbine engine, or more broadly an anomaly in the values for the fuel flow rate, and/or the temperature and/or the output rotational speed of a high-pressure turbine of the turbine engine, and/or the output pressure of a compressor of the turbine engine, and/or the torque, and/or detecting the extinction of a combustion chamber of the turbine engine, and/or a leak on an oil circuit, and/or a leak in a fuel circuit, and/or detecting a swarf, and/or an inability to regulate the performance of the turbine engine, and/or an inconsistency between the power demand and the power supplied. These potential anomalies result in failures of the first turbine engine which generally require rapid reactivation of the second turbine engine because they may be symptomatic of a significant loss of power of the first turbine engine.

Alternatively, the third condition C3 comprises detecting flight conditions rapidly requiring operation in nominal mode 2 of the second turbine engine, or comprises receiving by the second turbine engine a reactivation instruction issued by an on-board computer and/or an aircraft pilot.

The step 14 of rapid reactivation is different from the two previous types of reactivation. In particular, the step 14 of rapid reactivation comprises the use of a specific starting system configured and sized to provide a strong assist torque and implement a fuel flow rate law making a reactivation time of between 5 and 15 seconds, around 10 seconds, possible.

However, the step 14 of rapid reactivation has a high impact on the ageing of the second turbine engine and is only used in an emergency.

Among the three types of reactivation, the step 10 of normal reactivation is preferred over the step 12 of accelerated reactivation, and the step 12 of accelerated reactivation is also preferred over the step 14 of rapid reactivation. Indeed, reactivation with a low impact on ageing is preferred, although the first duration is longer than the second duration, and the second duration is longer than the third duration.

Optionally, the second turbine engine comprises an electric assist machine and each of the steps of normal reactivation, accelerated reactivation, or rapid reactivation comprises a step of assisting the second turbine engine by the electric assist machine of the aircraft.

In other words, the electric assist machine participates in rotating the second turbine engine when it is reactivated in order to accelerate said reactivation.

Optionally, the first, second and third conditions also each comprise an additional condition for maintaining the flight altitude of the aircraft over the time necessary for reactivating the second turbine engine. Indeed, although the step 10 of normal reactivation is preferred because it only has a small impact on the ageing of the second turbine engine, if this does not make it possible to guarantee maintaining the flight altitude of the aircraft, a more rapid reactivation step will be preferred. The same reasoning applies to the step 12 of accelerated reactivation.

In addition, a reactivation step may be interrupted in favour of another reactivation step when the conditions of the other reactivation step are met.

For example, when a step 10 of normal reactivation is in progress, but an anomaly indicating a major failure is detected, a step 14 of rapid reactivation is performed. However, if the specific starting system has a failure 16, a step 12 of accelerated reactivation is finally performed.

In one implementation, the method is implemented continuously by a computer of the second turbine engine as long as the second turbine engine is not in the nominal mode 2 of operation thereof. Thus, the search for identification of a need to reactivate the second turbine engine stops only when the second turbine engine is in the nominal mode 2 of operation thereof.

1. Method for managing the exiting of a specific-consumption mode of an aircraft equipped with a first turbine engine operating in a nominal mode and a second turbine engine operating in a standby mode or in a consumption mode intermediate to the standby mode and to the nominal mode of the second turbine engine, the method comprising a step of identifying a need to reactivate the second turbine engine in the nominal mode of said second turbine engine and a step of:
normal reactivation for a first duration of the second turbine engine in the nominal mode of said second turbine engine when the aircraft and/or the first turbine engine meets a first condition;
accelerated reactivation for a second duration of the second turbine engine in the nominal mode of said second turbine engine when the aircraft and/or the first turbine engine meets a second condition; and
rapid reactivation for a third duration of the second turbine engine in the nominal mode of said second turbine engine when the aircraft and/or the first turbine engine meets a third condition,
normal reactivation being preferred over accelerated reactivation, accelerated reactivation also being preferred over rapid reactivation, the first duration being longer than the second duration, and the second duration being longer than the third duration.

2. Method according to claim 1, wherein the step of identifying a need to reactivate the second turbine engine in the nominal mode of said second turbine engine comprises a step of detecting an anomaly of at least one operating parameter of the first turbine engine or comprises a step of receiving a reactivation instruction issued by an on-board computer and/or an aircraft pilot.

3. Method according to claim 1, wherein the step of normal reactivation and/or the step of accelerated reactivation and/or the step of rapid reactivation comprises a step of assisting the second turbine engine by an electric machine of the aircraft.

4. Method according to claim 1, wherein the step of normal reactivation comprises a step of thermally stabilising at a predefined temperature the second turbine engine or a step of gradually increasing the power of the second turbine engine until the powers provided between the first and second turbine engines are balanced, the step of normal reactivation further comprising implementing a fuel flow rate law making a reactivation time of between 1 and 3 minutes possible.

5. Method according to claim 1, wherein the step of accelerated reactivation comprises implementing a fuel flow rate law making a reactivation time of between 25 seconds and 45 seconds possible.

6. Method according to claim 1, wherein the step of rapid reactivation comprises using a specific starting system configured to implement an assist torque and a fuel flow rate law making a reactivation time of between 5 seconds and 15 seconds possible.

7. Method according to claim 1, wherein the first condition comprises receiving by the second turbine engine a reactivation instruction issued by an on-board computer and/or an aircraft pilot.

8. Method according to claim 1, wherein the second condition comprises detecting a failure on the first, for example among the loss of redundancy of a sensor, an excessive oil temperature, the loss of an energy source of the aircraft, or comprises detecting flight conditions requiring operation in nominal mode of the second turbine engine, or comprises receiving by the second turbine engine a reactivation instruction issued by an on-board computer and/or an aircraft pilot.

9. Method according to claim 1, wherein the third condition comprises detecting a fault on the first turbine engine, for example detecting an anomaly in the values for the fuel flow rate, and/or the temperature and/or the output rotational speed of a high-pressure turbine of the turbine engine, and/or the output pressure of a compressor of the turbine engine, and/or the torque, and/or detecting the switching off of a combustion chamber of the turbine engine, and/or a leak in an oil circuit, and/or a leak in a fuel circuit, and/or detecting a swarf, and/or an inability to regulate the performance of the turbine engine, and/or an inconsistency between the power demand and the power supplied, and/or comprises detecting flight conditions requiring operation in nominal mode of the second turbine engine, or comprises receiving by the second turbine engine a reactivation instruction issued by an on-board computer and/or an aircraft pilot.

10. Method according to claim 1, implemented continuously by a computer of the first and/or of the second turbine engines as long as the second turbine engine is not in the nominal mode of operation thereof, the first, second and third conditions also comprising a condition of maintaining the flight altitude of the aircraft over the time necessary for reactivating the second turbine engine.
